(19) United States
(12) Patent Application Publication
(10) Pub. No.: US 2007/0013216 A1
(43) Pub. Date: Jan. 18, 2007

(54) Car seat with adjustable armrest mechanism

(75) Inventor: Chuan-Ming Yeh, Chuayi City (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/482,810

(22) Filed: Jul. 10, 2006

(30) Foreign Application Priority Data
Jul. 12, 2005 (TW) 094211848

(51) Int. Cl. B60N 2/28

(52) U.S. Cl. 297/250.1

(57) ABSTRACT

A baby car seat capable of having the incline angles of the armrests adjusted, includes a base, a pair of armrests, an inclined-angle adjusting member and a resilient element. The lower end of the armrests and an inclined-angle adjusting member catch each other in order to secure the armrests at particular inclined angles, and the armrests are pivotally connected to the base at both sides thereof. The resilient element is disposed between the inclined-angle adjusting member and base, and is capable of providing resilience to make the inclined-angle adjusting member maintain its position relative to the lower ends of the armrests. The user can move the inclined-angle adjusting member from outside of the base to press the resilient element and temporarily separate the resilient element from the lower ends of the armrests. In this way, the armrests may be adjusted to a desired angle that is comfortable for the baby. As the user releases the inclined-angle adjusting member, the resilience of the resilient element will return the resilient element to its former position, thereby maintaining the inclined-angle adjusting member's position relative to the lower ends of the armrests, securing the position of the armrests at the adjusted incline angle.

This application claims priority of Application No. 094211848 filed in Taiwan, R.O.C. on Jul. 12, 2005 under 35 U.S.C. § 119, the entire contents of which are hereby incorporated by reference.

### BACKGROUND OF THE INVENTION

1. Field of the Invention

The invention relates to a baby car seat with an armrest and, in particular, to a baby car seat with an adjustable armrest mechanism capable of adjusting the inline angle of the armrest.

2. Description of the Prior Art

Normally, a baby car seat for an infant of around one year of age provides the infant with a lying-down function only. Therefore, the baby car seat is narrow and substantially flat and straight. A seat belt is provided on the car seat for securing the infant, and the baby car seat itself also makes use of the standard seat belt provided in the car. The applicable type and size of the baby car seat required for a child three-years of age and up differs from the above-mentioned baby car seat for an infant, since the child's body is relatively bigger than the infant's and is capable of sitting directly on the regular car seat.

However, as far as the body of a child three-years of age or older is concerned, if the standard safety belt already provided in the car is used without also using a baby car seat, the buckled safety belt will often pass across the portion of the child's body between the shoulder and the neck. This leaves the child's neck at risk of being entangled by the safety belt and resulting in an accidental injury, if the child's body and head dash forward when the car is suddenly braked.

In addition, the incline angle of the armrests of the baby car seat applicable to a child three-years of age and up is not substantially adjustable. Although the height of the armrests of the baby car seat of a few of the most current cars is capable of being adjusted, this adjustment is only possible in an up-and-down (parallel) motion. However, the incline angles cannot be adjusted. Therefore, there is still some room for improving comfort of the baby car seat.

### SUMMARY OF THE INVENTION

In order to resolve the above-mentioned problem, the present invention provides a baby car seat capable of having the incline angle of the armrests adjusted, such that the operator can select an angle for the armrests which achieves the desired comfort level.

The embodiment of the baby car seat capable of adjusting the incline angles of the armrests includes a base, a pair of armrests, an inclined-angle adjusting member, and a resilient element. The lower end of the armrests and an inclined-angle adjusting member catch each other, in order to secure the armrests at particular inclined angles, and the armrests are pivotally connected to the base at both sides thereof. The resilient element is disposed between the inclined-angle adjusting member and the base, and is capable of providing resilience, in order to make the inclined-angle adjusting member maintain its position relative to the lower ends of the armrests. The user can press the inclined-angle adjusting member from outside of the base, in order to move the resilient element and temporary separate the resilient element from the lower end of the armrests. In this way, the armrests may be adjusted to a desired angle that is comfortable for the baby. As the user releases the inclined-angle adjusting member, the resilience of the resilient element will return the resilient element to its former position, thereby maintaining the inclined-angle adjusting member's position relative to the lower ends of the armrests, and secure the position of the armrests at the adjusted incline angle.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an isometric exploded view of the baby car seat of the present invention;

FIG. 2 is a side view of the assembled baby car seat of the present invention;

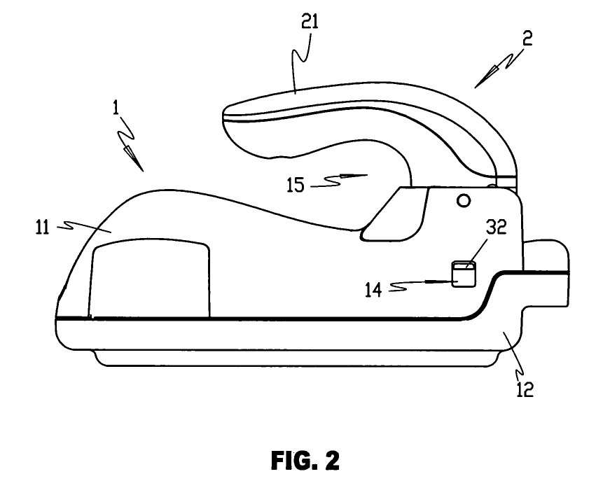

FIG. 3 is a schematic side view showing the action of adjusting the armrest of the baby car seat of the present invention;

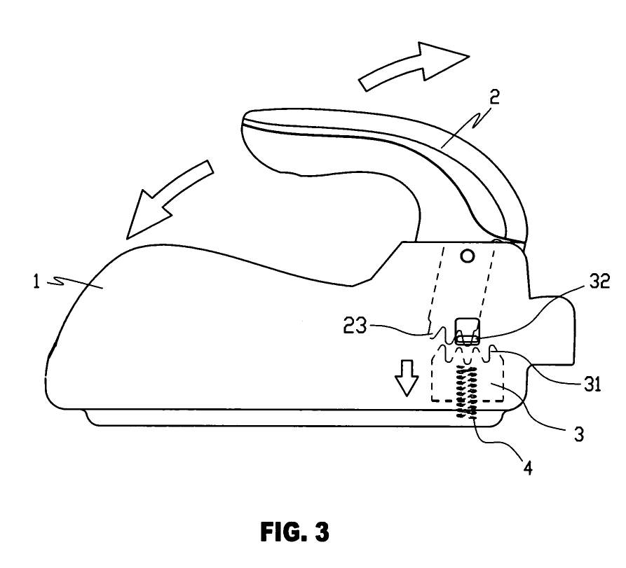

FIG. 4 is a schematic side view showing the rotational positions of the armrest of the baby car seat of the present invention; and

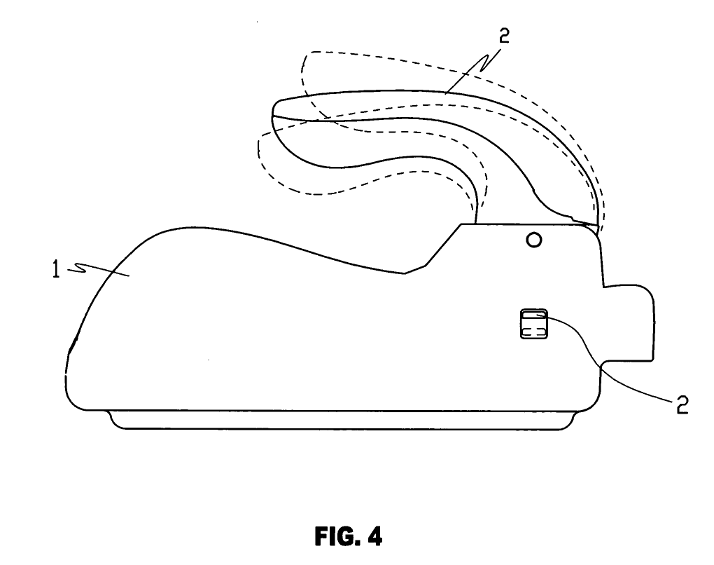

FIG. 5 is a schematic cross-sectional view showing the transverse movement of the inclined-angle member of the armrest of the baby car seat of the present invention.

### DETAILED DESCRIPTION OF THE PREFERRED EMBODIMENT

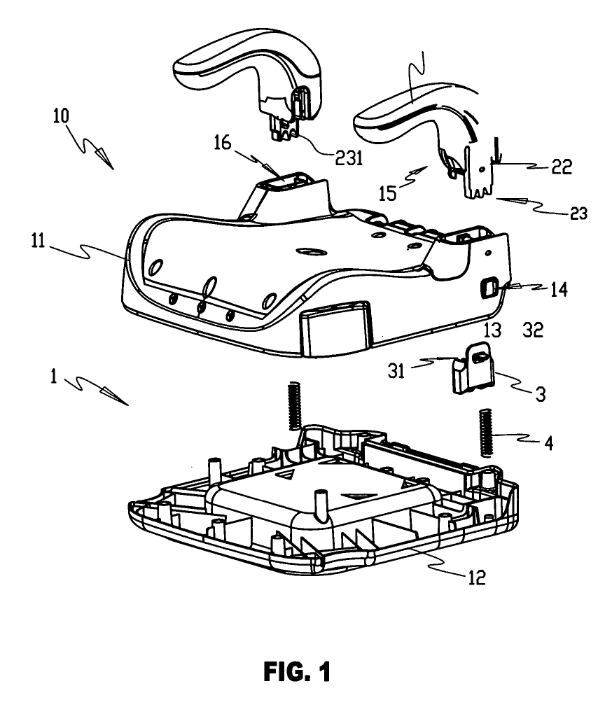

Shown in FIGS. 1˜4 is an embodiment of the baby car seat of the present invention. The baby car seat of the present invention includes a base (1), a pair of armrests (2), an inclined-angle adjusting member (3), and a resilient element (4).

The base (1) provides the baby with a riding space, and consists of an upper seat (11) and a lower seat (12). Each of the two sides (13) of the base (1) provides an adjusting hole (14) and inserting slots (16).

The armrest (2) is pivotally connected to both sides of the base (1), and includes a resting portion (21) substantially parallel to the base (1) and a connecting portion (22) inserted into the inserting slots (16) and pivotally connected to the base (1), thereby making the armrest (2) capable of rotating with respect to the base (1) as well as making the resting portion (21) of the armrest (2) capable of changing the incline angle. A limiting space (15) for limiting buckling of the safety belt is formed between the connecting portion (22) and the base (1). A catching portion (23) having a jigsaw or tooth shape with indented-and-salient surfaces is formed at the lower end of the connecting portion (22), thereby providing a plurality of positioning locations for catching.

The inclined-angle adjusting member (3) being installed below the catching portion (23) of the armrest (2) includes a positioning portion (31) and an operating block (32). The positioning portion (31) and the catching portion (23) are capable of catching or separating from each other. The operating block (32), which protrudes from the inclined-angle adjusting member (3), is capable of making the operator utilize the operating block (32) to catch the inclined-angle adjusting member (3). The operating block (32) can be exposed directly out of the base (1), i.e., can be exposed out of the base (1) through the adjusting hole (14). This allows the operating block (32) to be pressed to move the inclined-angle adjusting member (3) so as to make the positioning portion (31) temporarily separate from the catching portion (23), such that the armrests (2) may be freely adjusted to a desired incline angle.

The resilient element (4) is provided between the inclined-angle adjusting member (3) and the base (1), and provides resilience to make the positioning portion (31) and the catching portion (23) maintain a fitted position, such that the armrests (2) are secure in their angle of incline. As the operator presses the operating block (32) to make the inclined-angle adjusting member (3) press the resilient element (4), the positioning portion (31) will separate from the catching portion (23), and the armrests (2) may then be freely rotated to a desired incline angle. After the incline angles are adjusted, the resilience of the resilient element (4) will return the resilient element to its former position, thereby securely catching the positioning portion (31) and the snatching portion (23) together.

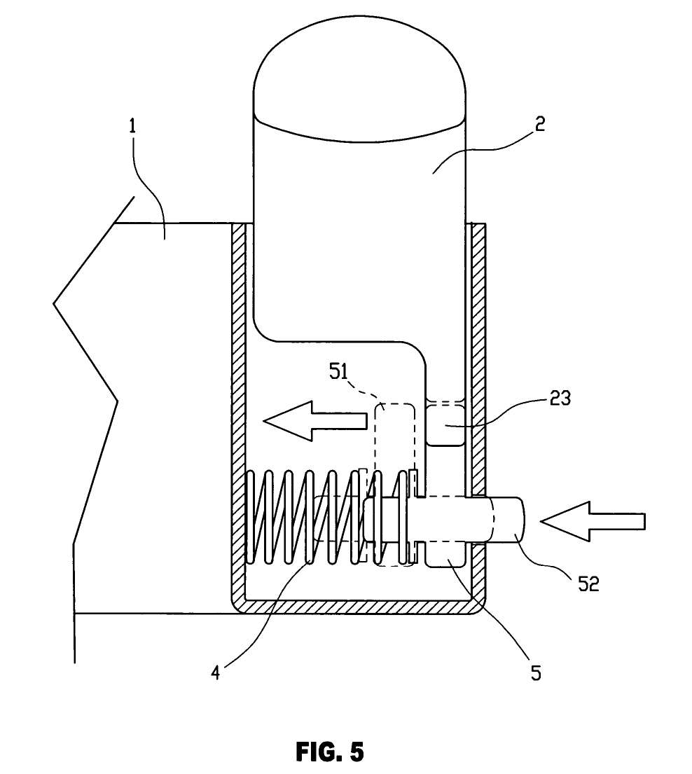

FIG. 5 shows a variation of the embodiment of the invention. As shown in FIG. 5, the variation lies in changing the up-and-down motion of the inclined-angle adjusting member (5) into a reciprocating motion, by directly pressing the operating block (52). This allows the positioning portion (51) of the inclined-angle adjusting member (5) to separate from the catching portion (23) of the armrests (2), such that the armrests (2) may then be freely rotated to a desired incline angle. After releasing the operating block (52), the resilience of the resilient element (4) will return the resilient element to its former position, thereby catching the positioning portion (51) and the snatching portion (23) together, to securely fix the armrests (2) at the desired incline angle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A baby car seat comprising:
a base for providing a riding space;
a pair of armrests pivotally connected to both sides of the base and having a catching portion at the lower end thereof, wherein the catching portion is capable of being rotated to change the incline angle of the armrests;
an inclined-angle adjusting member having a positioning portion in contact with and capable of catching the catching portion, the inclined-angle adjusting member being provided between the base and the armrests in such way that the inclined-angle adjusting member is capable of performing a reciprocating motion, and wherein the catching portion separates from the positioning portion while it is moving; and
a resilient element disposed between the inclined-angle adjusting member and the base, which provides resilience to maintain the positioning portion's position relative to the catching portion, thereby securing the position of the armrests at the adjusted incline angle.

2. The baby car seat as claimed in claim 1, wherein the pair of armrests further comprises a resting portion and a connecting portion, the resting portion being provided for the baby to rest his or her arms, and the connecting portion being pivotally connected to the base.

3. The baby car seat as claimed in claim 1, wherein the catching portion is positioned at the lower end of the connecting portion.

4. The baby car seat as claimed in claim 1, wherein the catching portion has a jigsaw or tooth shape with indented-and-salient surfaces.

5. The baby car seat as claimed in claim 1, wherein an adjusting hole is provided at both sides of the base to expose the inclined-angle adjusting member for the user to press.

6. The baby car seat as claimed in claim 1, wherein the inclined-angle adjusting member has an operating block protruding therefrom, the operating block being exposed through the adjusting hole for the user to press the inclined-angle adjusting member.

7. The baby car seat as claimed in claim 1, wherein the inclined-angle adjusting member has an operating block protruding therefrom the operating block being exposed out of the base for the user to press the inclined-angle adjusting member.

8. The baby car seat as claimed in claim 1, wherein the resilient element is a spring.

9. The baby car seat as claimed in claim 1, wherein the inclined-angle adjusting member can be pressed to move up-and-down, such that the positioning portion and the catching portion are capable of either catching or separating from each other.

10. The baby car seat as claimed in claim 1, wherein the inclined-angle adjusting member can be pressed to perform a reciprocating motion, such that the positioning portion and the catching portion are capable of either catching or separating from each other.
